(19) United States
(12) Patent Application Publication
(10) Pub. No.: US 2026/0014696 A1
(43) Pub. Date: Jan. 15, 2026

(54) MECHANICAL ARM WITH HIGH LOAD-BEARING CAPACITY

(71) Applicant: ZHEJIANG DINGLI MACHINERY CO., LTD., Huzhou (CN)

(72) Inventors: Zhong Xu, Huzhou (CN); Shugen Xu, Huzhou (CN)

(21) Appl. No.: 17/894,126

(22) Filed: Aug. 23, 2022

(30) Foreign Application Priority Data
Dec. 31, 2021 (CN) 2021116544975

(51) Int. Cl. B25J 9/04; B25J 15/06; B25J 18/02

(52) U.S. Cl. CPC B25J 9/04; B25J 18/025; B25J 15/0616

(57) ABSTRACT

A mechanical arm with high load-bearing capacity includes a base used for installing an adsorption device, a main swing device, an telescopic device, a pitching device and a secondary swing device; the main swing device and the secondary swing device are used for driving the base to swing perpendicularly to a gravity direction; the secondary swing device is connected with the base; the telescopic device and the pitching device are arranged between the main swing device and the secondary swing device; one end of the telescopic device is connected with the main swing device, and the other end of the telescopic device is connected with the pitching device; and an end, far away from the telescopic device, of the pitching device is connected with the secondary swing device. The present disclosure optimizes the structural layout of the mechanical arm, and therefore the load-bearing capacity is improved effectively.

### CROSS REFERENCE TO RELATED APPLICATION

This application claims the benefit of and priority to Chinese Patent Application No. 2021116544975, filed Dec. 31, 2021, the entire disclosure of which is incorporated herein by reference in its entirety.

### TECHNICAL FIELD

The present disclosure relates to the technical field of mechanical arms, in particular to a mechanical arm with high load-bearing capacity.

### BACKGROUND ART

With the continuous development of a building technology, a large number of integral building materials may be used sometimes in order to achieve the more attractive appearance of a building or facilitate the construction of the building. For example, when a glass curtain wall is constructed on a building surface, a large number of whole pieces of glass will be used. In an erection process, the building height, the weight of a single building material and other factors present a big challenge to a construction process.

Chinese patent (application number: CN200820056342.5, and publication number: CN201183739Y) discloses a hydraulic rotary vacuum four-claw glass hoist which includes an electric vehicle powered and driven by a battery, as well as a support installed on the electric vehicle, a plurality of motion arms installed on the support, a set of oil pressure lifting mechanism and a set of vacuum loading mechanism; the oil pressure lifting mechanism includes an oil pump powered and driven by the battery, and a plurality of oil cylinders connected with an oil circuit of the oil pump, and the plurality of oil cylinders are in transmission connection with the plurality of motion arms respectively; and the vacuum loading mechanism includes a vacuum pump powered and driven by the battery, a suction pad bracket connected to a front end of the oil pressure lifting mechanism, and a plurality of vacuum suction pads connected to the suction pad bracket, and the plurality of vacuum suction pads are connected with a gas circuit of the vacuum pump respectively. Although a technical solution of the patent provides the hoist capable of achieving aerial installation of building materials instead of labor, a load-bearing capacity of the hoist is lower in the technical solution of the patent due to influence of a mechanical arm structure of the hoist, and the hoist cannot be used for driving the heavier building materials.

### SUMMARY

Aiming at the technical problems in the prior art, the present disclosure provides a mechanical arm with high load-bearing capacity.

In order to solve the above technical problems, the present disclosure provides the following technical solution:

The mechanical arm with high load-bearing capacity includes a base used for installing an adsorption device, a main swing device, an telescopic device, a pitching device and a secondary swing device; the main swing device and the secondary swing device are used for driving the base to swing perpendicularly to a gravity direction; the secondary swing device is connected with the base; the telescopic device and the pitching device are arranged between the main swing device and the secondary swing device; one end of the telescopic device is connected with the main swing device, and the other end of the telescopic device is connected with the pitching device; and one end, far away from the telescopic device, of the pitching device is connected with the secondary swing device.

Under the condition that building materials are adsorbed by the adsorption device, when an orientation of the base needs to be adjusted to make the building materials aligned to an area ready for installation, the main swing device can be controlled to act; when the main swing device acts, since a swing direction of the base is perpendicular to the gravity direction, the main swing device does not need to bear dead weights of other components (namely the building materials) of the mechanical arm in an action process of the main swing device, and therefore the load of the main swing device is reduced; and similarly, the load of the secondary swing device is also reduced. The telescopic device can also be controlled to act for driving the base to extend or retract. The pitching device can also be controlled to act for driving the base to pitch up or down; although the pitching device has to resist gravity in the action process, the pitching device does not need to bear the gravity of the main swing device and the telescopic device in the action process due to influence of the position where the pitching device is located, and therefore the load of the pitching device is reduced. The secondary swing device can also be controlled; and as the secondary swing device closest to the base, with the minimum load applied thereto; and, a size and a weight of the secondary swing device can be reduced properly, so as to further reduce loads applied to other devices. Therefore, the present disclosure optimizes the structure of the mechanical arm effectively, and through a rational arrangement sequence, on the premise that the mechanical arm has multiple dimensions of activity, the load applied to each device is reduced properly, and therefore the load-bearing capacity is improved effectively.

Furthermore, an accommodating groove is formed in the telescopic device; and the main swing device is embedded into the accommodating groove.

Furthermore, spacing is formed between the main swing device and a bottom of the accommodating groove.

Furthermore, a reinforcing plate is further arranged on the telescopic device; the reinforcing plate is fixedly connected with the telescopic device; and the reinforcing plate extends from one end of the telescopic device to the other end of the telescopic device.

Furthermore, the pitching device includes mounting plates and a pitching oil cylinder; the mounting plates extend from the secondary swing device to the telescopic device; one end of the pitching oil cylinder is connected with the corresponding mounting plate in a swingable mode; the other end of the pitching oil cylinder is in transmission connection with the secondary swing device; and when the pitching oil cylinder acts, the secondary swing device can be driven to pitch up or down.

Furthermore, the base includes a longitudinal regulating plate, a transverse regulating plate and a mounting part; the mounting part is used for installing the secondary swing device, and the longitudinal regulating plate is capable of moving relatively to the mounting part in parallel with the gravity direction; the transverse regulating plate is connected with the adsorption device; the transverse regulating plate is capable of moving relatively to the mounting part and perpendicularly to the gravity direction.

Furthermore, a mounting groove used for accommodating the secondary swing device is formed in the mounting part; longitudinal oil cylinders are further arranged on two sides of the mounting part; and the longitudinal oil cylinders are connected with the longitudinal regulating plate, so that the longitudinal regulating plate is driven to move relatively to the mounting part.

Furthermore, one side of the transverse regulating plate is slidably connected with the longitudinal regulating plate; and the other side of the transverse regulating plate is connected with the adsorption device.

Furthermore, a connecting groove and a transverse oil cylinder are arranged on the transverse regulating plate; the longitudinal regulating plate is embedded into the connecting groove; the transverse oil cylinder is embedded into the connecting groove, and the transverse oil cylinder is arranged on one side of the longitudinal regulating plate; and the transverse oil cylinder is connected with the longitudinal regulating plate, so that the longitudinal regulating plate is driven to move relatively to the mounting part.

In conclusion, the present disclosure has the following advantages:
1. Through a rational structural layout, the bearing load of the main swing device in the action process is reduced, and the structure of the main swing device can be reinforced to improve the load-bearing capacity;
2. By utilizing the characteristics of a simple structure and a single action process of the telescopic device, and in combination with the rational structural layout, the structural strength of the telescopic device can be improved, and the load-bearing capacity of the telescopic device is improved;
3. The pitching device is complicated in action process, and has to resist the gravity of other components in the action process, but through the rational layout, the bearing load of the pitching device is reduced, and therefore the structure of the pitching device can be simplified to a certain extent, so as to reduce the weight of the pitching device and relieve the bearing load of other devices;
4. By utilizing the accommodating groove in the telescopic device and the mounting groove in the base, an overall length of the mechanical arm can be shortened, and therefore the load-bearing capacity of the mechanical arm is improved;

5. Through a rational combination mode, a thickness of the base is smaller, thereby benefiting reduction in the overall length of the mechanical arm, and the load-bearing capacity of the mechanical arm is improved.

The beneficial effects of further or other details will be described in the embodiments.

### BRIEF DESCRIPTION OF THE DRAWINGS

FIG. 1 is a front view of an overall structure;

FIG. 2 is an isometric projection drawing of the overall structure;

FIG. 3 is an enlarged view of an Area A in FIG. 1;

FIG. 4 is an exploded view of a base;

Wherein, 1—Base, 11—Longitudinal regulating plate, 12—Transverse regulating plate, 121—Connecting groove, 122—Transverse oil cylinder, 13—Mounting part, 131—Mounting groove, 132—Longitudinal oil cylinder, 2—Main swing device, 3—Telescopic device, 31—Accommodating groove, 32—Reinforcing plate, 33—Load-bearing part, 34—Telescopic part, 4—Pitching device, 41—Mounting plate, 42—Pitching oil cylinder, 411—Transmission arm, 412—Extension part, and 5—Secondary swing device.

### DETAILED DESCRIPTION OF THE EMBODIMENTS

Orientations, such as upper, lower, left, right, front, rear, front side, back side, top and bottom, which are mentioned or may be mentioned in the specification, are defined relative to structures shown in the figures; the words “inner” and “outer” refer to directions facing or keeping away from geometric centers of specific components respectively, which are relative, and therefore corresponding changes may be made according to different positions where the components are located, and different using states of the components. Therefore, these terms or other orientation terms should not be explained as restrictive terms.

The present disclosure will be further described with reference to embodiments:

### Embodiment

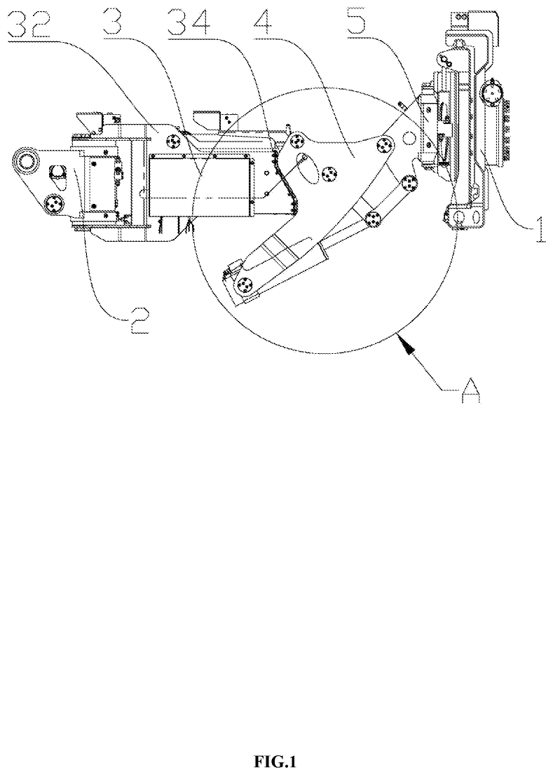

A mechanical arm with high load-bearing capacity includes a base 1 used for installing an adsorption device, a main swing device 2 used for driving the base 1 to swing perpendicularly to a gravity direction, an telescopic device 3 used for driving the base 1 to extend or retract, a pitching device 4 used for driving the base 1 to pitch up or down, and a secondary swing device 5 used for driving the base 1 to swing perpendicularly to the gravity direction. Specifically, the content is shown in FIG. 1. The secondary swing device 5 is connected with the base 1. The main swing device 2 and the secondary swing device 5 are arranged at intervals. The telescopic device 3 and the pitching device 4 are arranged between the main swing device 2 and the secondary swing device 5. One end of the telescopic device 3 is connected with the main swing device 2, and the other end of the telescopic device 3 is connected with the pitching device 4. The end, far away from the telescopic device 3, of the pitching device 4 is connected with the secondary swing device 5.

In an actual state, the main swing device 2 bears the weights of the whole mechanical arm and adsorbed building materials. Due to the influence of a mounting position of the main swing device 2, an increase in the weight of the main swing device 2 does not impose an additional load on other components of the mechanical arm, and therefore the structure of the main swing device 2 can be reinforced properly; and for example, a thickness of each component of the main swing device 2 is increased, the strength is improved internally to reinforce the structure, etc., so as to improve the load-bearing capacity of the main swing device 2. When the main swing device 2 acts, the main swing device 2 only needs to resist a friction force between the components in the action process, and does not need to resist the gravity of the mechanical arm and the building materials, which benefits reduction in the bearing load of the main swing device 2 in the action process.

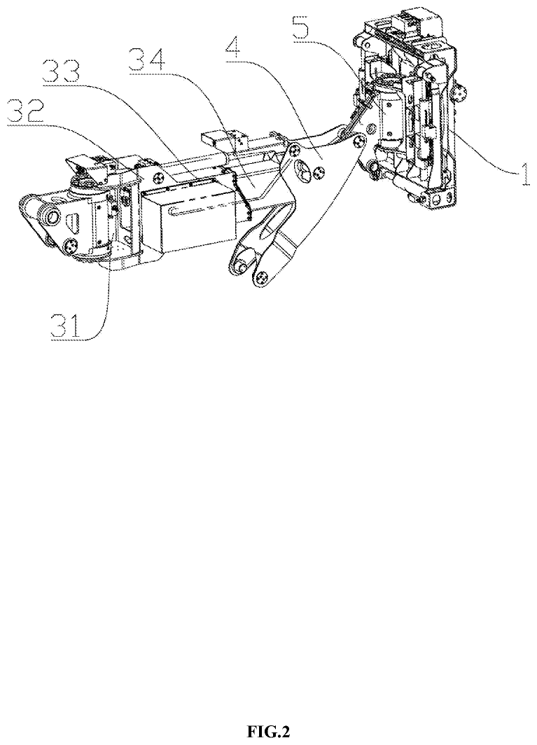

The telescopic device 3 includes a load-bearing part 33 and an telescopic part 34. Specifically, the content is shown in FIG. 2. The telescopic part 34 is connected with the pitching device 4, and the telescopic part 34 is nested in the load-bearing part 33 slidably. A push oil cylinder is arranged on the load-bearing part 33. An accommodating groove 31 is formed in the load-bearing part 33, and the main swing device 2 is embedded into the accommodating groove 31; and an overall length of the mechanical arm can be reduced by using the accommodating groove 31, so as to further reduce the bearing load of the main swing device 2. Meanwhile, spacing is formed between the main swing device 2 and a bottom of the accommodating groove 31, on one hand, interference generated between the load-bearing part 33 and the main swing device 2 in the action process of the main swing device 2 can be avoided effectively, and on the other hand, a swing angle of the load-bearing part 33 can be increased to a certain extent. It is worthwhile to note that the spacing should not be too large, to avoid excessively affecting the strength of connection between the load-bearing part 33 and the main swing device 2. A reinforcing plate 32 used for improving the structural strength is further arranged on the load-bearing part 33, and the reinforcing plate 32 extends from one end of the load-bearing part 33 to the other end of the load-bearing part 33. In an actual state, the telescopic device 3 bears other weights except for the main swing device 2. Meanwhile, the telescopic device 3 is simpler in structure and single in action process, the weight has little effect on the load applied to the main swing device 2 even being increased, and thus the structural strength of the telescopic device 3 can be improved properly, so as to improve the load-bearing capacity of the telescopic device 3.

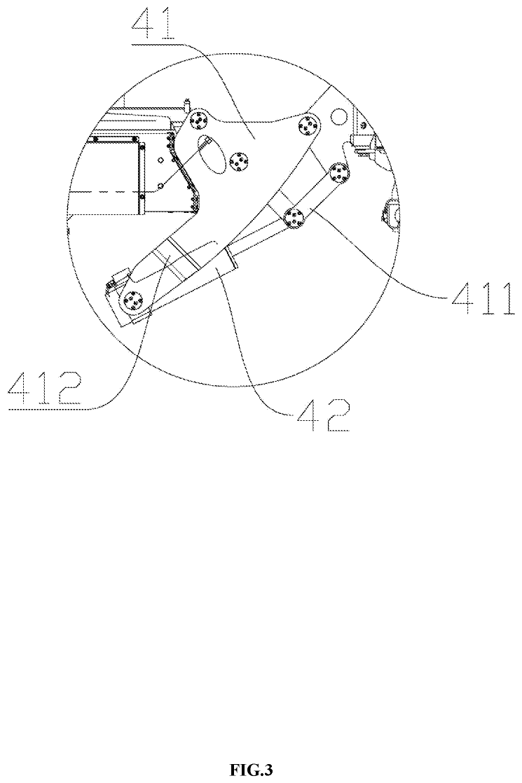

The pitching device 4 includes mounting plates 41 and a pitching oil cylinder 42. Specifically, the structure is shown in FIG. 3. The two mounting plates 41 are provided, and the two mounting plates 41 are arranged at intervals to reserve a space for installing the pitching oil cylinder 42. The mounting plates 41 are connected with the telescopic part 34, the mounting plates 41 are connected with the push oil cylinder, and a side, far away from the telescopic device 3, of each mounting plate 41 is connected with the secondary swing device 5 in a swingable mode. Meanwhile, a transmission arm 411 is further arranged between the mounting plates 41, one end of the transmission arm 411 is connected with the corresponding mounting plate 41 in the swingable mode, and the other end of the transmission arm 411 is connected with the secondary swing device 5 in the swingable mode. Extension parts 412 are further arranged on the mounting plates 41, and the extension parts 412 extend towards the telescopic device 3 from the secondary swing device 5. One end of the pitching oil cylinder 42 is connected with the extension part 412 in the swingable mode, and the other end of the pitching oil cylinder 42 is connected with the transmission arm 411 in the swingable mode. Therefore, the pitching oil cylinder 42 is obliquely arranged on a side, close to the ground, of the telescopic device 3, so as to effectively utilize a space around the telescopic device 3, and therefore the overall length of the mechanical arm is shortened, and the bearing loads of the telescopic device 3 and the main swing device 2 are reduced. When the pitching oil cylinder 42 acts, the transmission arm 411 is driven to act, so as to drive the secondary swing device 5 to act, and finally the base 1 is driven to pitch up or down. In the actual state, the action process of the pitching device 4 is more complicated, the pitching device 4 has to resist the gravity of other components in the action process, and accordingly the intrinsic load-bearing capacity is lower. However, the pitching device 4 does not need to bear the weights of the main swing device 2 and the telescopic device 3, and thus the structure of the pitching device 4 can be simplified properly, so as to reduce the weight of the pitching device 4 (the pitching device is of a hollow structure consisting of the two mounting plates 41 in the present disclosure) to reduce the loads applied to the main swing device 2 and the telescopic device 3.

To sum up, through rational layout of the components of the mechanical arm, the load-bearing capacities of the components are fully utilized, and the bearing loads of the components for the dead weight of the mechanical arm are reduced, so that the load-bearing capacity of the mechanical arm for the building materials is improved effectively.

The secondary swing device 5 is connected with the base 1 directly, the bearing load is the minimum, and the secondary swing device 5 only needs to resist a friction force between the components in the action process; and therefore, the structure of the secondary swing device 5 can be simplified, and the weight of the secondary swing device 5 is reduced, so as to reduce the bearing loads of other devices.

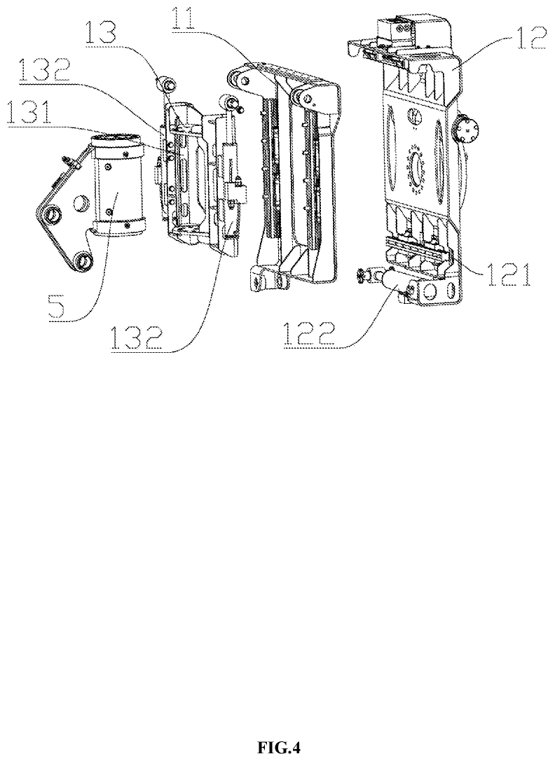

The base 1 includes a longitudinal regulating plate 11, a transverse regulating plate 12 and a mounting part 13. Specifically, the content is shown in FIG. 4. A mounting groove 131 is formed in the mounting part 13, and the secondary swing device 5 is embedded into the mounting groove 131, so that the connection between the secondary swing device 5 and the mounting part 13 is more compact, so as to shorten the overall length of the mechanical arm, and reduce the bearing loads of other devices. Longitudinal oil cylinders 132 are further installed on two sides of the mounting part 13 fixedly. The longitudinal regulating plate 11 is of an approximately rectangular structure, and is connected with the mounting part 13 by a sliding rail slidably. Output ends of the longitudinal oil cylinders 132 are connected with the longitudinal regulating plate 11, and when the longitudinal oil cylinders 132 act, the longitudinal regulating plate 11 can be driven to slide relatively to the mounting part 13 in parallel with the gravity direction. The transverse regulating plate 12 is of a rectangular structure connected with the adsorption device. A connecting groove 121 and a transverse oil cylinder 122 are further arranged on the transverse regulating plate 12. The longitudinal regulating plate 11 is embedded into the connecting groove 121, and the transverse regulating plate 12 is slidably connected with the longitudinal regulating plate 11 by the sliding rail. The transverse oil cylinder 122 is embedded into the connecting groove 121, and the transverse oil cylinder 122 is located on a side, close to the ground, of the longitudinal regulating plate 11. One end of the transverse oil cylinder 122 is connected with the transverse regulating plate 12, and the other end of the transverse oil cylinder 122 is connected with the longitudinal regulating plate 11; and when the transverse oil cylinder 122 acts, the transverse regulating plate 12 can be driven to slide relatively to the longitudinal regulating plate 11 and perpendicularly to the gravity direction. In conclusion, in the above combined connection mode, by increasing the length of the base 1, the thickness of the base 1 is reduced, and therefore the overall length of the mechanical arm is reduced; and the bearing loads of other devices are reduced, and the overall load-bearing capacity of the mechanical arm is improved.

Although the preferred embodiments of the present disclosure have been described, additional changes and modifications can be made to these embodiments by those skilled in the art once they know basic creative concepts. Therefore, the accompanying claims are intended to cover the preferred embodiments and all changes and modifications falling within the scope of the present disclosure.

Apparently, various modifications and variations can be made to the present disclosure by those skilled in the art without deviating from the spirit and scope of the present disclosure. In this way, if these modification and variations of the present disclosure fall within the scope of the claims of the present disclosure and equivalent technologies thereof, the present disclosure is intended to cover these modifications and variations.

1. A mechanical arm with high load-bearing capacity, comprising a base used for installing an adsorption device, a main swing device, an telescopic device, a pitching device and a secondary swing device;
the main swing device and the secondary swing device are used for driving the base to swing perpendicularly to a gravity direction;
the secondary swing device is connected with the base;
the telescopic device and the pitching device are arranged between the main swing device and the secondary swing device;
one end of the telescopic device is connected with the main swing device, and the other end of the telescopic device is connected with the pitching device; and
an end, far away from the telescopic device, of the pitching device is connected with the secondary swing device.

2. The mechanical arm with high load-bearing capacity according to claim 1, wherein an accommodating groove is formed in the telescopic device; and
the main swing device is embedded into the accommodating groove.

3. The mechanical arm with high load-bearing capacity according to claim 2, wherein spacing is formed between the main swing device and a bottom of the accommodating groove.

4. The mechanical arm with high load-bearing capacity according to claim 2, wherein a reinforcing plate is further arranged on the telescopic device; the reinforcing plate is fixedly connected with the telescopic device; and the
reinforcing plate extends from one end of the telescopic device to the other end of the telescopic device.

5. The mechanical arm with high load-bearing capacity according to claim 1, wherein the pitching device comprises mounting plates and a pitching oil cylinder; the mounting plates extend from the secondary swing device to the telescopic device; one end of the pitching oil cylinder is connected with the corresponding mounting plate in a swingable mode; the other end of the pitching oil cylinder is in transmission connection with the secondary swing device; and when the pitching oil cylinder acts, the secondary swing device can be driven to pitch up or down.

6. The mechanical arm with high load-bearing capacity according to claim 1, wherein the base comprises a longitudinal regulating plate, a transverse regulating plate and a mounting part; the mounting part is used for installing the secondary swing device, and the longitudinal regulating plate is capable of moving relatively to the mounting part in parallel with a gravity direction; the transverse regulating plate is connected with the adsorption device; and the transverse regulating plate is capable of moving relatively to the mounting part and perpendicularly to the gravity direction.

7. The mechanical arm with high load-bearing capacity according to claim 6, wherein a mounting groove used for accommodating the secondary swing device is formed in the mounting part; longitudinal oil cylinders are further arranged on two sides of the mounting part; and the longitudinal oil cylinders are connected with the longitudinal regulating plate, so that the longitudinal regulating plate is driven to move relatively to the mounting part.

8. The mechanical arm with high load-bearing capacity according to claim 6, wherein one side of the transverse regulating plate is slidably connected with the longitudinal regulating plate; and the other side of the transverse regulating plate is connected with the adsorption device.

9. The mechanical arm with high load-bearing capacity according to claim 8, wherein a connecting groove and a transverse oil cylinder are arranged on the transverse regulating plate; the longitudinal regulating plate is embedded into the connecting groove; the transverse oil cylinder is embedded into the connecting groove, and the transverse oil cylinder is arranged on one side of the longitudinal regulating plate; and the transverse oil cylinder is connected with the longitudinal regulating plate, so that the longitudinal regulating plate is driven to move relatively to the mounting part.
